(19) United States
(12) Patent Application Publication
(10) Pub. No.: US 2002/0170377 A1
(43) Pub. Date: Nov. 21, 2002

(54) Sturdy folding bicycle

(76) Inventor: William J. Stephens, Boston, MA (US)

Correspondence Address: Donald N. Halgren, 35 Central Street, Manchester, MA, 01944, US

(21) Appl. No.: 09/862,172

(22) Filed: May 21, 2001

(51) Int. Cl. B62K 21/16

(52) U.S. Cl. 74/551.3

(57) ABSTRACT

Improved components are provided for a bicycle which is powered by pedals, motor, or engine. Such bicycle can be folding or non-folding. The two components are 1) lever-locked handlebars mounted upon a sturdy steering column and 2) a sturdy offset seat column which can be height-adjustable. Included is a handle bar assembly having a pair of foldable handle bars mounted to a center section, which is mounted in turn on a steering column. Each of the handle bars has a cam mounted thereto with a lever attached to the cam, so that when each handle bar is pivoted up to its extended operating position, a lever and cam are pivoted so that the cam overlaps the center section in close proximity, holding each handle bar in such extended position. Pulling the levers out of their respective pockets and pivoting them and their cams in the reverse directions, releases the respective handlebars so that they can fold downwardly toward the steering column in a compact manner. The seat column is offset in order that it may fold around the steering column when used in a folding bicycle and the steering column, with folded handle bars, can fold toward and, e.g., over such seat column. The offset nature of the seat column also permits axial movement of seat column segments which can be fixed at desired elevations for a height-adjustable seat column.

### FIELD OF THE INVENTION

This invention relates to a folding bicycle, particularly one that has sturdy, foldable components.

### BACKGROUND OF THE INVENTION

Techniques to reduce cycle size e.g., during shipping or storage is frequently desirable such as for bicycles, including folding bicycles. However, when the folding bicycle is unfolded to its extended operating position, it's unfolded position should be sturdy and not prematurely fold, e.g., the handle bars should not fold suddenly under the downward pressure of use, which can unbalance both rider and cycle.

As for seat columns, some of these in the past have terminated at the upper end thereof in a gooseneck shape on which the seat rests so as to be sufficiently offset to better fold around a (folding) steering column. See, for example, FIGS. 3 and 4 of U.S. Pat. No. 4,634,138 to Fryer et all (1987). However, bending of a tube to achieve such gooseneck tends to weaken the upper part of the support feeling for the rider on such seat. Also the gooseneck shape of such seat column does not permit lowering the seat height beyond the first bend thereof.

In the prior art are U.S. Pat. No. 353,504 to Rodes (1886), as to folding handle bars and U.S. Pat. No. 5,590,895 to Hiramoto (1997) as to adjustable-height seat columns.

As to the first feature, the Rodes reference has a pair of levers ‘D’ which, instead of locking the handle bars in an extended operating position, pivot to release such handle bars to fold upwardly together, when the bicycle hits an obstacle, causing the rider's knees to hit the levers, so he can be thrown or jump forward, clear of the bicycle.

Such release levers are in contrast to applicant's locking levers which serve to hold their locking cams in place, which levers cannot be accidently dislodged by the knees and even if they were, the handlebars would still be locked by the cams (without considerable counter rotation of the levers). Thus the Rodes knee levers are for handle bar release while the levers of the invention are for locking cams and their associated handlebars in the operating position.

As to the second feature, the Hiramoto reference shows a bicycle with a seat column passing through a lower seat column tube at an angle thereto longitudinally of the bicycle, so that the seat height may be adjustable, but such column is not laterally offset so as to fold around the steering column and does not fold at all. Rather, the bicycle folds back on itself in two planes with the respective columns both pointing skyward rather than being folded toward each other.

Accordingly, there is need and market for improvements to the above adjustable cycle features that overcome the above prior art shortcomings.

There has now been discovered a folding handle bar assembly for a cycle that can securely lock the handle bars in place in the elevated, extended position yet readily release such handle bars for folding and compact storage. There has also been discovered an offset bicycle column suitable for folding around a folding steering column that is of sturdy design and can include an ample height-adjustment feature.

### BRIEF SUMMARY OF THE INVENTION

Broadly, the present invention provides a handle bar assembly for a cycle comprising, a pair of handle bars pivotably mounted to a center section, the center section being mounted to the upper portion of a steering column, each handle bar having a cam mounted thereto proximate the center section when each handle bar is pivoted up to its extended operating position, so that when the cam is pivoted, it overlaps said center section in close proximity, holding the handle bar in its extended position and when the cam is pivoted out of overlap with the center section, the handle bar can be folded downwardly of the center section.

The invention further provides a seat column for a cycle wherein the lower and thereof is mountable to a cycle frame and the upper end is supportable of a cycle seat, which column comprises, a lower shaft and an upper shaft, the upper shaft being joined to the lower shaft and offset axially therefrom by an offset coupling member.

In a preferred embodiment, the upper shaft of such seat column is axially moveable through the offset coupler and fixable therein at spaced points, so as to adjust the height of a seat mounted thereon. Definitions:

By “cycle,” as used herein is meant, a vehicle of two or more wheels, foldable or not and powered by pedals, motor or engine.

### BRIEF DESCRIPTION OF THE DRAWINGS

The invention will become more apparent from the following detailed, specification and drawings in which;

FIG. 1 is a perspective view, of a folding bicycle of the prior art;

FIG. 2 is an elevation view of the bicycle of FIG. 1 in the folded position;

FIG. 3 is a plan view of the folding bicycle of FIG. 2;

FIGS. 4,5,6 and 7 are fragmentary perspective views of various positions of the lever-locked handle bars embodying the present invention;

FIG. 8 is a fragmentary plan view of the above embodiments of FIGS. 4-7;

FIG. 9 is a fragmentary elevation schematic view of the embodiment of FIG. 8;

FIG. 10 is a perspective fragmentary schematic view of a seat column embodiment of the present invention;

FIG. 11 is an elevation schematic view of a foldable bicycle embodiment of the present invention carrying loaded bags on the lever-locked handle bars embodying the invention and

FIG. 12 is an enlarged fragmentary schematic view of steering components of the embodiment of FIG. 11.

### DESCRIPTION OF PREFERRED EMBODIMENTS

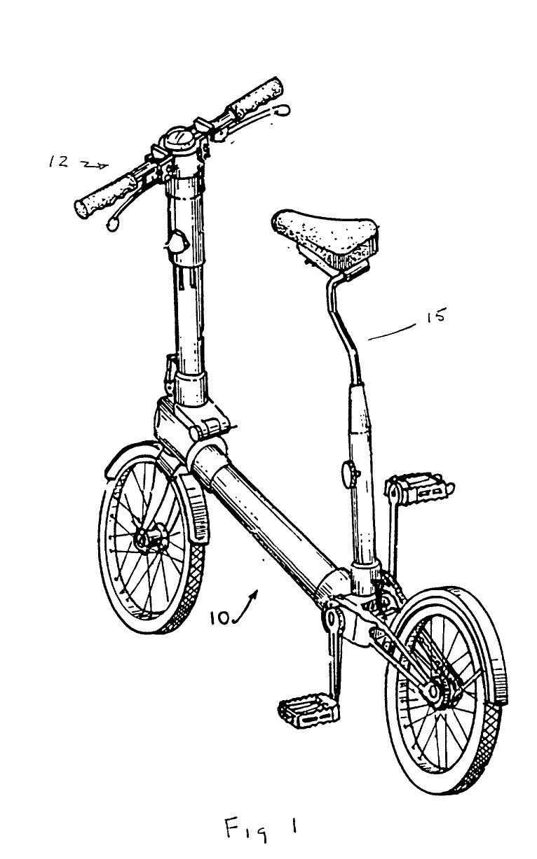

Referring in more detail to the drawings, a folding bicycle, which has components that fold in the same plane, is shown in drawings of the prior art, FIGS. 1,2 and 3 and more fully disclosed in U.S. Pat. No. 4,634,138, which is incorporated herein by reference. That is, the folding bicycle 10 of FIG. 1 has folding handle bars 12, which are best shown in FIGS. 6,7 and 8 of such patent.

In this reference, the handle bars 30 and 32, pivot respectively on pins 38 and 40, mounted in the holder 28 and lock into the extended operational position by spring latch means 42, having handle 45, as shown in such FIGS. 6,7 and 8.

Sometimes however, under downward pressure of one or more of the handle bars, the spring latch means can slip out of its socket causing such handle bar to suddenly fold downwardly, which can unbalance rider and bicycle.

The present invention intends to provide a more secure locking mechanism for its handle bars, as shown in FIGS. 4 to 7, wherein handle bars 22 and 24 are lever locked in the extended position, as shown in such Figures. That is, handle bar 22 is secured by cam 26, attached to lever 52, which extends into aperture 54, while cam 28 has lever 56, which extends into aperture 58 so to lock handle bars 22 and 24 in the extended position as shown or indicated in FIGS. 4 and 5. Levers 52 and 56 are flexed under spring tension to snap into their respective apertures 54 and 58, as indicated in FIG. 5.

The cams 26 and 28 are oblong in the closed position so as to extend over the junction of handle bar with the center section 23, which cams, however, disengage with such section 23 when the lever and cam are pivoted away therefrom, as shown by the pivoting of cam 28 and lever 56 in FIGS. 6, 8 and 9.

The above pivoting action allows the handle 24 (as well as handle 22) to pivot downwardly, on hinge pin 25, per FIGS. 6,7 and 9, close to the steering column in a compact position. The center section 23 is open underneath to permit pivoting of the handle bars 22 and 24 thereunder, as indicated in FIGS. 6 and 7.

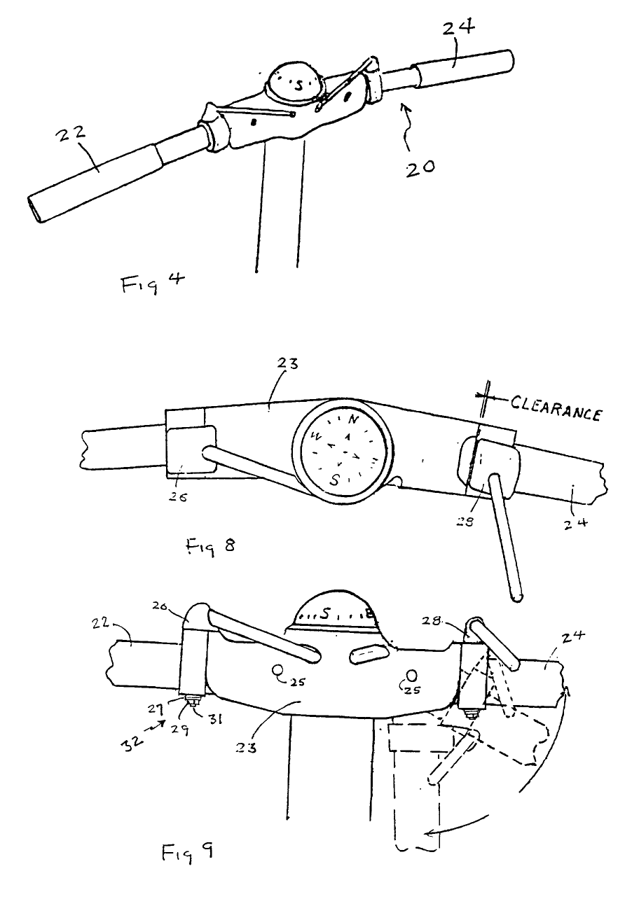

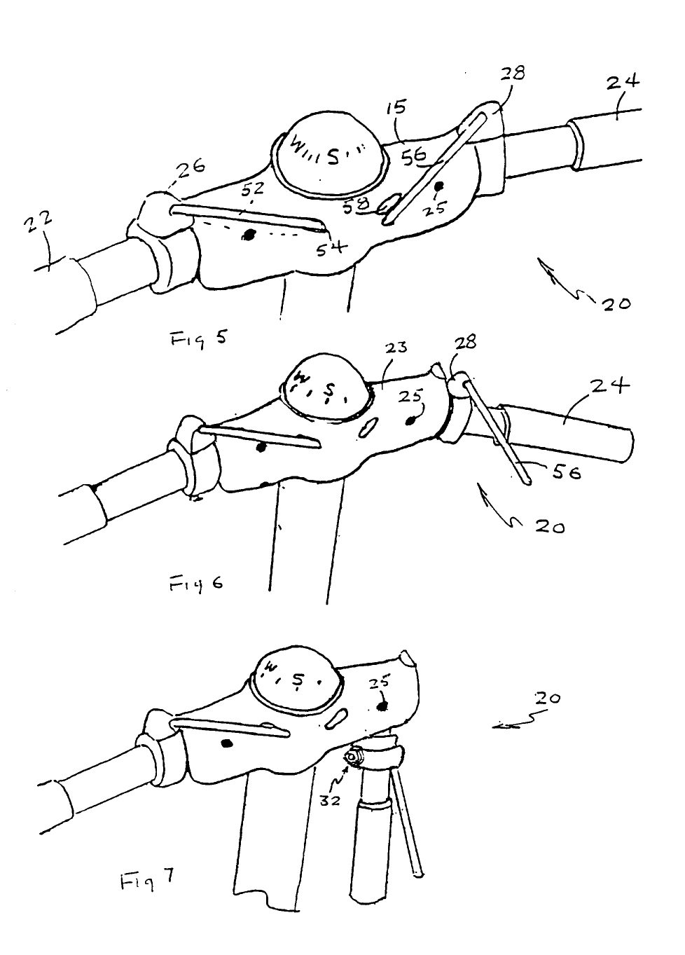

The relative positions of the respective cams is best shown in FIGS. 8 and 9, wherein cam 26 is engaged and cam 28 is disengaged to allow folding of the handle bar 24 as shown.

As shown in FIG. 9, cam 26 is secured to handle bar 22 by a threaded bolt 31, which passes through fastener 32, which includes two washers 27 and a threaded nut 29. this is but an example of how cams 26 and 28 can be fastened to their respective handle bars 22 and 24, as indicated in FIGS. 7 and 9.

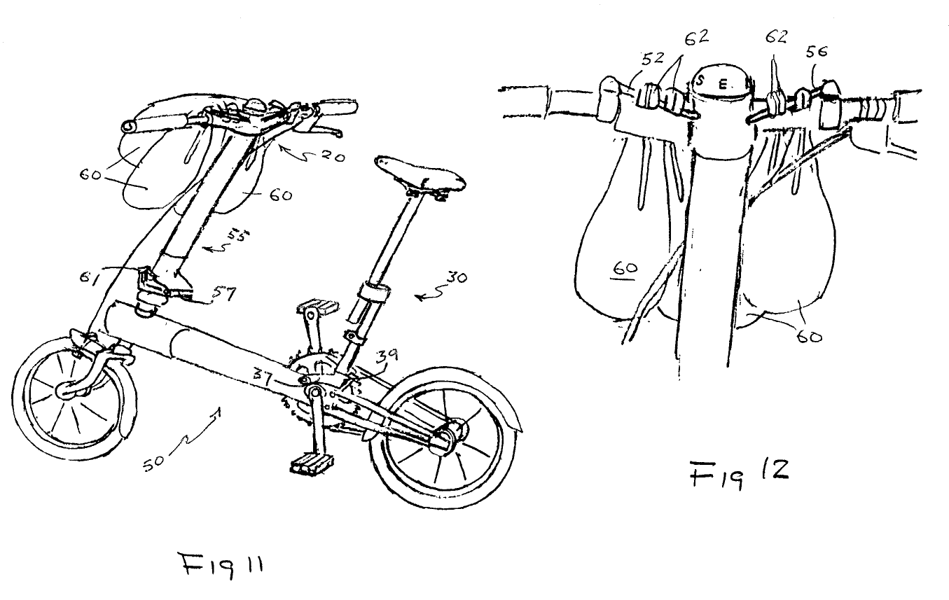

A secondary advantage of the lever-locked handle bars of the invention, is that the levers 52 and 56 (of FIGS. 4-9) can, when closed, be used to carry shopping bags 60, having handles 62, as shown in FIGS. 11 and 12 hereof.

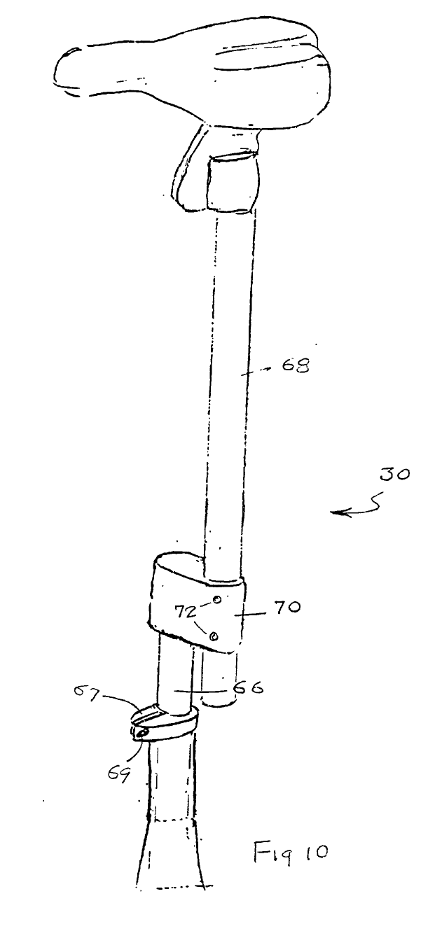

Finally, another improvement is provided for the bicycle 10 of FIG. 1 wherein the gooseneck's seating column 15, which has had a tendency to wobble in use, is replaced by the more sturdy seat column 30, shown in FIG. 10, which has offset segments 66 and 68, joined by offset coupler 70, as shown in FIG. 10.

Note that the offset segment 68 in FIG. 10 extends through the offset coupler 70 and can move axially up and down therein and be fixed, e.g., by set screws 72 at a desired position. Likewise, the lower offset segment 66 can move axially through clamp 67 and be fixed by clamp screw 69 at a desired elevation. Thus the offset seat column 30 of the invention is readily height adjustable.

The lever-locked handle bars and/or the telescoping seat column embodiments of the invention can be employed on various cycles, including bicycles with the advantages noted above.

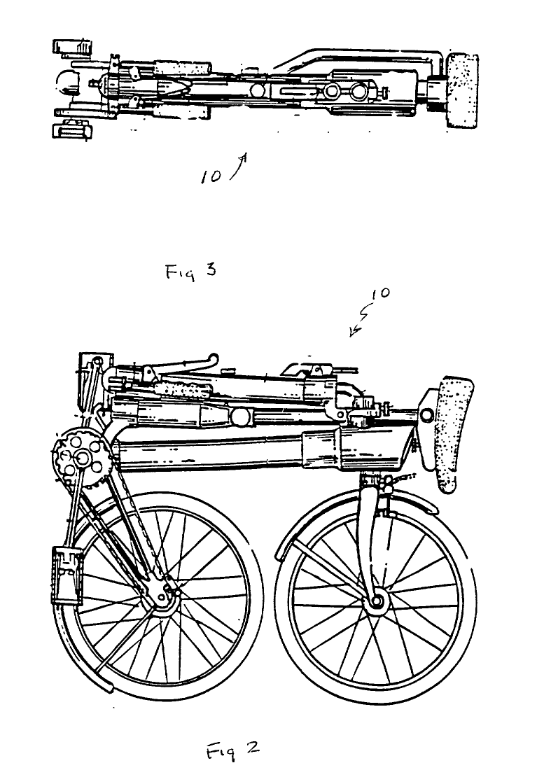

Thus one or both of the above novel components can be employed on a bicycle such as shown in FIG. 1 and folded in the manner shown in FIGS. 2 and 3 hereof. In such case the pedals desirably fold to provide the compact package shown in such FIGS. 2 and 3.

In the case where both steering column 12 and seat column 15 of bicycle 10 are replaced with the improved embodiments thereof described above, one will have the improved folding bicycle 50 shown, e.g., in FIG. 11, with the lever-locked handle bar assembly 20 on sturdy steering column 55 and with sturdy offset seat column 30.

Where the bicycle of the invention folds in the manner of FIGS. 1,2 and 3 hereof, it can employ hinging of the respective components of such bicycle, as disclosed in the above-cited patent which, as noted above, is incorporated herein by reference.

For example, folding of the steering column 55 at hinge 57 and folding of seat column 30 on a spaced pair of pivot arms, e.g., pivot arm 31, are shown in FIG. 11.

The hinge 57 is restrained by locking member or thumb screw 61 and the pivot arm 37 is restrained by locking member 39, per FIG. 11.

Again the improved bicycle 50, e.g., of FIG. 11, will fold into a compact package in a manner similar to that shown in FIGS. 2 and 3 hereof.

The folding bicycle of the invention, e.g., per FIG. 11, can have various sized wheels and various sized lever-locked handle bars. Also such bicycle can employ various sized sprockets, gear shifting means and braking systems, within the scope of the present invention.

An advantage of the inventive seat column is that it has a double telescoping ability and can readily adapt for use by a tall or short rider by a quick axial adjustment of one or both offset segments of the seat column 30.

As for the lever-locked handle bar assembly, several advantages are apparent. That is, the levers provide a high mechanical advantage in pivoting the cams and holding them in place. Also the ends of the levers have a snap action feel as they click into the locking position so the rider knows they are locked. Further the so-locked levers can securely hold bags of groceries or other items per FIGS. 11 and 12, the weight of which only augments the locking action of such levers in their mating apertures.

Also, having the ends of the levers snap into place in their respective apertures, with or without shopping bags loaded thereon, insures against inadvertent unlocking of such levers.

As discussed above, the invention relates to lever-locked handle bars on a sturdy steering column and/or an offset height-adjustable seat column for a cycle of two or more wheels, which includes a bicycle foldable or not, powered by pedals and/or powered by an engine or motor, as desired, within the scope of the invention.

What is claimed is:

1. A handle bar assembly for a cycle comprising, a pair of handle bars pivotably mounted to a center section, said center section being mounted to the upper portion of a steering column, each handle bar having a cam mounted thereto proximate said center section when each handle bar is pivoted up to its extended operating position, so that when said cam is pivoted, it overlaps said center section in close proximity, holding said handle bar in said extended position and when said cam is pivoted out of overlap with said center section, said handle bar can be folded downwardly of said center section.

2. The handle bar assembly of claim 1 wherein each of said cams has a lever extending therefrom.

3. The handle bar assembly of claim 2 wherein when each handle bar is pivoted to its extended operating position and said lever is pivoted towards said center section, its respective cam pivots into overlap with said center section, and the distal end of such lever can be pushed into a mating detent or aperture in said center section, to secure said lever, its cam and handle bar in said extended position.

4. The handle bar assembly of claim 1 wherein when each of said cams pivots into overlap with said center section, it pivots towards said center section.

5. The handle bar assembly of claim 4 wherein each of said cams has a lever projecting therefrom.

6. The handle bar assembly of claim 5 wherein when said cam pivots into overlap with said center section, the distal end of its lever pivots into proximity with a mating detent, which distal end can be urged into said detent by flexing said lever in a spring fit, locking the associated handle bar in an extended operating position.

7. The handle bar assembly of claim 6 wherein said handle bar is unlocked by pulling said lever out of said detent and pivoting lever and cam away from said center section until said cam no longer overlaps therewith and said handle bar can be folded or pivoted toward said steering column.

8. The handle bar assembly of claim 6 wherein one or more handles of carrying bags can be placed around said lever before it is snapped into its mating detent, so that such one or more bags can be carried over said handle bar assembly secured by the so-locked levers.

9. The handle bar assembly of claim 6 in which said steering column pivotably mounts to the frame of a bicycle.

10. The handle bar assembly of claim 9, wherein said bicycle is powered by pedals, a motor, an engine or combination thereof.

11. The handle bar assembly of claim 9 having a seat column pivotably mounted to a cycle frame, said cycle frame being mounted to front and rear wheels,
means for folding said steering column and said seat column into proximity with each other and a portion of said frame and
means for positioning said front and rear wheels below said frame when said cycle is folded, to define a folding bicycle.

12. A seat column for a cycle, wherein the lower end thereof is mountable to a cycle frame and the upper end is supportable of a cycle seat, which column comprises, a lower shaft and an upper shaft, said upper shaft joined to said lower shaft and offset axially therefrom by an offset coupling member.

13. The seat column of claim 12, wherein a steering column is also mounted to said frame and said seat column is offset so as to fit around said steering column when said seat column folds toward said steering column.

14. The seat column of claim 12 wherein said lower shaft is axially moveable into said cycle frame and fixable at various elevations therein so as to adjust the height of a seat mounted on said column.

15. The seat column of claim 12 wherein the upper shaft thereof is axially moveable through said offset coupling member and fixable therein at various points so as to adjust the height of a seat mounted thereon.

16. The seat column of claim 13 wherein said frame is mounted on front and rear wheels and means for positioning said wheels below said frame, when said cycle is folded, to define a folding bicycle.

17. The seat column of claim 12, wherein a steering column is also mounted to said frame and said frame is mounted on front and rear wheels to define a bicycle.

18. The seat column of claim 17, wherein said bicycle is powered by pedals, a motor, and engine or combination thereof.
